(19) United States
(12) Patent Application Publication
(10) Pub. No.: US 2026/0056933 A1
(43) Pub. Date: Feb. 26, 2026

(54) CONFLICT RESOLUTION FOR OBJECT METADATA

(71) Applicant: HITACHI VANTARA LLC, Santa Clara, CA (US)

(72) Inventors: Ravi MISHRA, Bangalore (IN); Ronald TRIMBLE, Wilmington, MA (US)

(21) Appl. No.: 18/874,608

(22) PCT Filed: Jun. 30, 2022
(86) PCT No.: PCT/US2022/035771

§ 371 Date: Dec. 13, 2024

(51) Int. Cl. G06F 16/23; G06F 16/27

(52) U.S. Cl. CPC G06F 16/2365; G06F 16/27

(57) ABSTRACT

In some examples, a first computing system receives a first metadata change made to metadata of a first instance of an object stored at a storage location of the first computing device. The first computing system associates, with the first metadata change, a time of the first metadata change. Based on receiving replication of a second instance of the object from a second computing system, the first computing system determines that a second metadata change was made to metadata of the second instance of the object. Further, the second instance of the object includes a time of the second metadata change. The first computing system at least one of: resolves a conflict between the first metadata change and the second metadata change based at least on comparing the times, or merges the first metadata change with the second metadata change into the metadata for the object.

### TECHNICAL FIELD

This disclosure relates to the technical field of data storage.

### BACKGROUND

Data objects, such as files or other object types, may typically include object data and object metadata. For example, the object data includes the content of the object. The object metadata may include information about the object data, such as the location of the object data in a filesystem, system-generated information about the object, user-generated information about the object, and so forth.

When replication of metadata is performed across multiple computing systems, such as for providing redundancy protection, the same metadata may exist on multiple different computing systems. In such a topology, it is possible that the same object metadata may be modified at the same time by different users at different computing systems. When metadata is changed differently at the different computing systems, the results can lead to data inconsistencies, unintended loss of data, or other undesirable consequences.

### SUMMARY

In some implementations, a first computing device of a first computing system receives a first metadata change made to metadata of a first instance of an object stored at a storage location of the first computing device. The first computing device associates, with the first metadata change, a time of the first metadata change. Based on receiving replication of a second instance of the object from a second computing device of a second computing system, the first computing device determines that a second metadata change was made to metadata of the second instance of the object. Further, the second instance of the object includes a time of the second metadata change. In some cases, the first computing device may resolve a conflict between the first metadata change and the second metadata change based at least on comparing the time of the first metadata change with the time of the second metadata change. Additionally, or alternatively, in some cases, the first computing device may merge the first metadata change with the second metadata change into the metadata for the object.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture of a system able to replicate data between multiple computing systems while enabling merging of metadata changes made at the multiple computing systems according to some implementations.

FIG. 2 illustrates an example process for metadata conflict resolution according to some implementations herein.

FIG. 3 is a flow diagram illustrating an example process for detecting a metadata conflict according to some implementations.

FIG. 4 is a flow diagram illustrating an example process for conflict resolution and the merger of metadata changes according to some implementations.

FIG. 5 is a flow diagram illustrating an example process for performing cleanup following conflict resolution and merging of changes according to some implementations.

FIG. 6 illustrates an example of storing the last modification time and user information in association with metadata changes according to some implementations.

FIG. 7 illustrates an example of merging metadata changes according to some implementations herein.

FIG. 8 illustrates select example components of an example computing system that may be used to implement some of the functionality of the systems described herein.

### DESCRIPTION OF THE EMBODIMENTS

Some implementations herein are directed to techniques and arrangements for managing changes made to metadata at multiple different computing systems in a reliable manner by keeping track of the time at which each metadata change is made, as well as by determining a user role (e.g., user privileges) for the user who modified the metadata at each computing system. For example, by keeping track of the last modification time (LMT) and the user role, such as user privileges, for changes to individual pieces of metadata at each of the computing systems, implementations herein are able to handle multiple metadata changes made across multiple computer systems to avoid a situation in which some metadata changes might be lost due to replication processing or the like. The technique herein enables the preservation of individual metadata changes associated with a single object made at different computing systems, and is able to persist the changes that have been made at the different computer systems by different users concurrently (e.g. within the same replication cycle) without losing the individual changes.

Data loss because of inaccurate conflict resolution is a very common and complex problem in object storage. For instance, in an active-active replication topology, replication occurs in two directions between at least two computing systems. In an active-active replication topology, it is possible that the same object might be modified at the same time at different computing systems by different users having the same or different privileges. However, implementations herein are able to resolve any conflicts in the changes, and prevent the loss of data, even when two or more computing systems are configured for replication in an active-active multi-direction arrangement.

The examples herein are able to preserve and merge metadata changes by keeping track of the last modification time and the user privilege for changes to individual pieces of metadata, which enables the resolution of conflicts in metadata changes, such as across clusters of computing devices, such as which may be arranged in a ring topology or other replication configurations. Furthermore, implementations herein are not limited to resolving conflicts just by checking the last modification time of the individual metadata, but may also apply a preference based on a user role (e.g., user privileges) associated with each metadata change.

In some examples herein, each computing system participating in replication is responsible to detect and keep track of changes to an object's metadata, and store it back into the object so that changes can be transferred subsequently to another system during a next replication cycle. Each system may employ the same logic to compare locally stored data with the remote side data transferred under a replication cycle to merge metadata changes at the individual metadata level so that finally a merged object's metadata may contain changes from each side without losing each side's changes. Further, even in a highly scalable model it is still possible that multiple systems may enable a change to an object's metadata at same time. In this situation, the roles of the users who modified the metadata on each side may be used as a tie breaker for resolving a conflict.

The merging of metadata changes at the object level according to implementations herein is advantageous in avoiding data loss across computing systems in synchronous modes of replication and in asynchronous modes of replication. Further, the solution herein is highly scalable, and can be used in an N-dimensional replication system. In addition, the solution herein can be used even in a heterogeneous environment, such as where on one side the data and metadata is stored in primary disk drive, or the like, and on another side the data and metadata is stored in a cloud-based storage over a network. Furthermore, even though the amount of extra space used to store the additional information employed for keeping track of last modification time of individual pieces of metadata may not be significant in some examples, the additional information does not need to be persisted for a long period on the respective computing systems. To the contrary, after the information is used in conflict resolution and merging of the changes, the metadata change information can be deleted from the computing system.

In addition, the solution herein also functions in the situation in which the metadata is heterogeneous in nature, such as in the case that, on a first computing system, the objects have N types of metadata and, on a second computing system, the objects have M types of metadata. In some examples herein, preference can be given to the user who made the latest modification based on the user's role, and when the last modification time for an object's metadata does not provide a resolution, thus providing a more robust conflict resolution solution. Furthermore, while the techniques herein are able to resolve conflicts in metadata changes for objects, the solution herein can also be used for resolving conflicts between changes to different types of object data.

For discussion purposes, some example implementations are described in the environment of a plurality of computing systems that perform data replication in two directions. However, implementations herein are not limited to the particular examples provided, and may be extended to other types of computing system architectures, other types of storage environments, other types of client configurations, other types of data, and so forth, as will be apparent to those of skill in the art in light of the disclosure herein. For instance, while some examples are described in the context of resolving conflicts within the metadata of objects, similar techniques may be applied to resolve object-level conflicts of the data itself for some types of objects.

As one example, suppose that an object is a zip file containing two files (file a and file b). It is possible in dual computing system replication topology that file a of the zip file is modified on a first computing system and that file b of the zip file is modified on the second computing system. Accordingly, maintaining and using the conflict resolution technique herein on a per file basis, any conflicts can be resolved and a final merged zip file may contain both the modified version of file a and the modified version of file b.

As another example, if an object is a type of text file, a last modification time and user information of the user who made a change may be maintained for each line in the text file. Accordingly, multiple lines of the text file can be modified on different computing systems and the conflict resolution and merge techniques herein may be used to merge changed text files from two or more computing systems to contain the modified lines from each computing system without losing the changes made at any of the computing systems.

As still another example, suppose that an object is a type of image including pixels. Changes to the pixels may be tracked by maintaining a time record of each pixel change made at each computing system maintaining a copy of the image. The conflict resolution technique herein may be used to preserve and resolve the changes in the pixels to generate a merged image following replication.

As yet another example, the conflict resolution techniques herein may also be applied to object data that is subdivided, such as with each subdivision including a separate label. In this situation, each labeled subdivision of the data that is changed at one of the respective computing systems may have a last modification time and user information associated with its respective label. Subsequently, the changes may be merged and/or conflict resolution performed following replication, similar to the techniques for the metadata changes discussed herein. Numerous other variations will be apparent to those of skill in the art having the benefit of the disclosure herein.

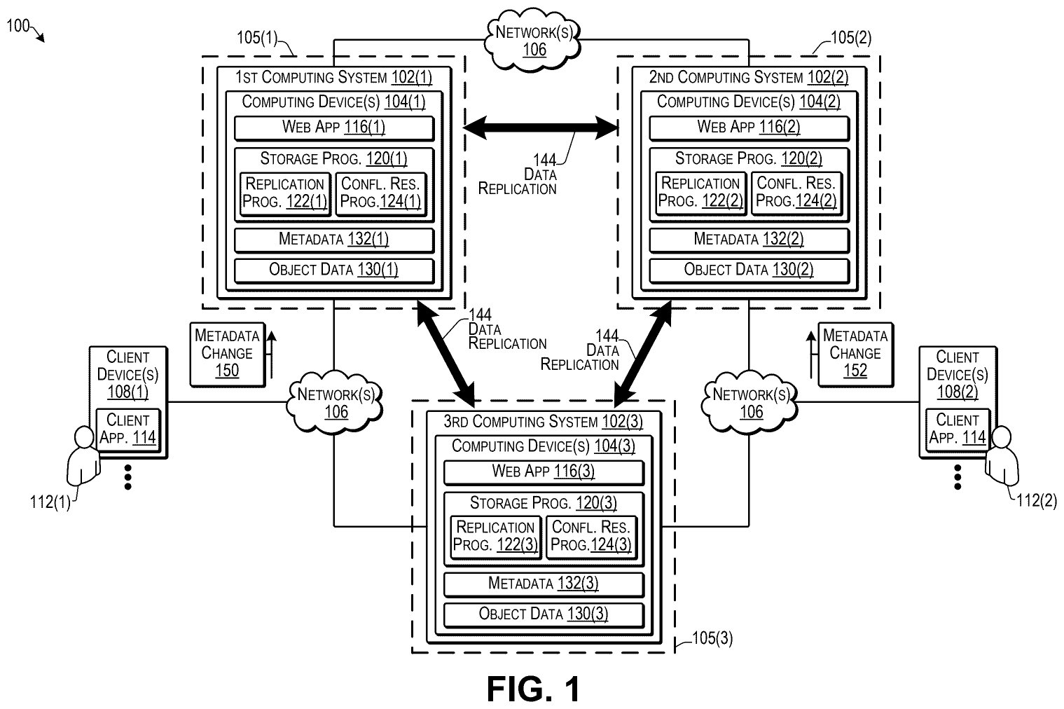

FIG. 1 illustrates an example architecture of a system 100 able to replicate data between multiple computing systems while enabling merging of metadata changes made at the multiple computing systems according to some implementations. The system 100 includes a plurality of computing systems 102 that each include one or more computing devices 104, respectively. For example, a first computing system 102(1) includes one or more computing devices 104(1), a second computing system 102(2) includes one or more computing devices 104(2), and a third computing system 102(3) includes one or more computing devices 104(3). In some examples, a plurality of the computing devices 104 at each computing system 102 may form a cluster of computing devices, or the like, but implementations are not limited to any particular configuration of the computing systems 104.

The computing systems 102 may be located at respective sites 105 and may be able to communicate with each other through one or more networks 106. For example, the first computing system 102(1) may be physically located at a first site 105(1) at a first geographic location, the second computing system 102(2) may be physically located at a second site 105(2) at a second geographic location that is remote from the first geographic location, and the computing system 102(3) may be physically located at a third site 105(3) that is remote from the first geographic location and the second geographic location. For instance, the second and third geographic locations may be sufficiently remote from the first geographic location and each other, such as in another city, another state, another country, etc., so that a disaster that affects the first computing system 102(1) at the first site 105(1) is not likely to affect the second computing system 102(2) at the second site 105(2), or the third computing system 102(3) at the third site 105(3), and vice versa. Accordingly, this topology provides redundancy in the data that is stored on the computing systems 102(1)-102(3) to avoid catastrophic loss of data.

In some examples, the computing systems 102 are able to communicate over the network(s) 106 with one or more client devices 108. For instance, the computing systems 102 may include access nodes, server nodes, management nodes, and/or other types of service nodes that provide the client devices 108 with storage services for enabling the client devices 108 to store data, as well as performing other management and control functions, as discussed additionally below. The client device(s) 108 may be any of various types of computing devices, as discussed additionally below.

The one or more networks 106 may include any suitable network, including a wide area network, such as the Internet; a local area network (LAN), such as an intranet; a wireless network, such as a cellular network, a local wireless network, such as Wi-Fi, and/or short-range wireless communications, such as BLUETOOTH®; a wired network including Fibre Channel, fiber optics, Ethernet, or any other such network, a direct wired connection, or any combination thereof. Accordingly, the one or more networks 106 may include both wired and/or wireless communication technologies. Components used for such communications can depend at least in part upon the type of network, the environment selected, or both. Protocols for communicating over such networks are well known and will not be discussed herein in detail. As one example, the network(s) 106 may include a private network, such as a LAN, storage area network (SAN), or Fibre Channel network. Additionally, the network(s) 106 may include a public network that may include the Internet, or a combination of public and private networks. Implementations herein are not limited to any particular type of network as the networks 106.

In some examples, the computing systems 102 may be configured to provide storage and data management services to client users 112 via the client device(s) 108, respectively. As several non-limiting examples, the client users 112 may include users performing functions for businesses, enterprises, organizations, governmental entities, academic entities, or the like, and which may include storage of very large quantities of data in some examples. Additionally, in some examples, the client users 112 may include administrative users that use the client devices 108 for managing one or more of the computing systems 102. Nevertheless, implementations herein are not limited to any particular use or application for the system 100 and the other example systems and arrangements described herein. For instance, in some examples, the client devices 108 may not be included or may be entirely different types of client devices.

Each client device 108 may be any suitable type of computing device such as a desktop, laptop, tablet computing device, mobile device, smart phone, wearable device, terminal, and/or any other type of computing device able to send data over a network. Client users 112 may be associated with client device(s) 108 such as through a respective user account, user login credentials, or the like. Furthermore, the client device(s) 108 may be configured to communicate with the computing systems 102 through the one or more networks 106, through separate networks, or through any other suitable type of communication connection. Numerous other variations will be apparent to those of skill in the art having the benefit of the disclosure herein.

In some implementations, each client device 108 may include a respective instance of a client application 114 that may execute on the client device 108, such as for communicating with a web application 116 executable on one or more of the computing devices 104 of the computing systems 102, such as for sending user data for storage on the network storages 104 and/or for receiving stored data from the network storages 104 through a data instruction, such as a write operation, read operation, delete operation, or the like. In some cases, the application 114 may include a browser or may operate through a browser, while in other cases, the application 114 may include any other type of application having communication functionality enabling communication with the web application 116 or other application on the computing systems 102 over the one or more networks 106. Further, in the case of an administrative user, the web application 116 may provide remote management functionality. Alternatively, in other examples, any of numerous other types of software arrangements may be employed for performing these functions, as will be apparent to those of skill in the art having the benefit of the disclosure herein.

The computing systems 102(1), 102(2), and 102(3), may each execute instances of a storage program 120(1), 120(2), and 102(3), respectively, which may include, or which may access or otherwise execute instances of a replication program 122(1), 122(2), and 122(3), respectively, and a conflict resolution program 124(1), 124(2), and 124(3), respectively. For example, the storage program 120 may provide access to stored object data 130 at each computing system 102, and may further manage the metadata 132 associated with the object data 130. Accordingly, the storage program 120(1) may access and store the object data 130(1) and may manage the associated metadata 132(1); the storage program 120(2) may access and store the object data 130(2) and may manage the associated metadata 132(2); and the storage program 120(3) may access and store the object data 130(3) and may manage the associated metadata 132(3). For instance, the storage program 120 may receive object data 130 from the client devices 108, may store the object data 130 on one or more storage devices at the network storage 104, and/or may retrieve and send requested object data 130 to the client devices 108, such as in response to a client read request, or the like.

The storage program 120 may also manage the metadata 132 associated with the object data 130. For example, the metadata 132 may be maintained separately from the object data 130 such as in a metadata database or any other suitable data structure. In some cases, the storage program 120 may generate a portion of the metadata 132, such as to indicate a storage location of the corresponding object data 130 of respective objects at the respective computing system 102.

In addition, the storage program 120 may include, may execute, may access, or may otherwise coexist with the data replication program 122, which may be configured to perform data replication, as indicated by data replication links 144, between the computing system 102(1), the computing system 102(2), and the computing system 102(3). For example, the data replication program 122 may configure the computing systems 102(1)-102(3) to perform asynchronous or synchronous data replication between the computing systems 102(1)-102(3). Further, in some examples herein, the computing systems 102 may employ a time synchronization program, such as NTP chrony, NTPD, or the like (not shown in FIG. 1), to maintain a precise synchronized time with each other.

Some examples herein may employ active-active data replication configurations. For instance in an active-active replication topology, replication can occur in two directions on a single link between two computing systems. As one example, in a simple active-active replication topology, two computing systems may replicate the same object data 130 and metadata 132 to each other over an active-active link. The items being replicated can be created originally on either computing system 102. The items may be read-write on the computing system 102 in which they were created and, after being replicated, may also be read-write on the other computing system 102. With active-active replication, client requests can be directed to any of the computing systems 102. All changes made on each computing system 102, including both metadata changes and changes to object content, are replicated to the other computing system(s) 102.

The example of FIG. 1 illustrates an active-active ring topology in which the three computing systems 102(1)-102(3) are connected by active-active replication links indicated at 144. With this topology, if one computing system 102 becomes unavailable (for example, either unexpectedly or for scheduled maintenance), the other two computing systems 102 can still provide all the required functionality. Further, in the active-active ring topology, each computing system 102 has two active-active links that connect that computing system 102 to the two other computing systems 102 in such a way that all the systems 102(1)-102(3) are linked in the form of a ring. The same object data 130 and metadata 132 may be replicated on each data replication link 144. Additionally, changes made on one system may travel around the ring in both directions from that computing system until the changes reach a computing system where those changes have already occurred.

Furthermore, while a ring topology of three computing systems 102 is illustrated in this example, in other examples there may be a greater number of computing systems 102 included in the ring topology. In addition, while some implementations herein may apply to active-active replication topologies, the implementations herein are not limited to such. For example, some implementations may be applied in various other replication scenarios, such as many-to-one, one-to-many, chained replication, and so forth. Further, these configurations may be combined to form complex replication topologies, as is known in the art, and implementations of the conflict resolution techniques herein may be applied to these topologies as well.

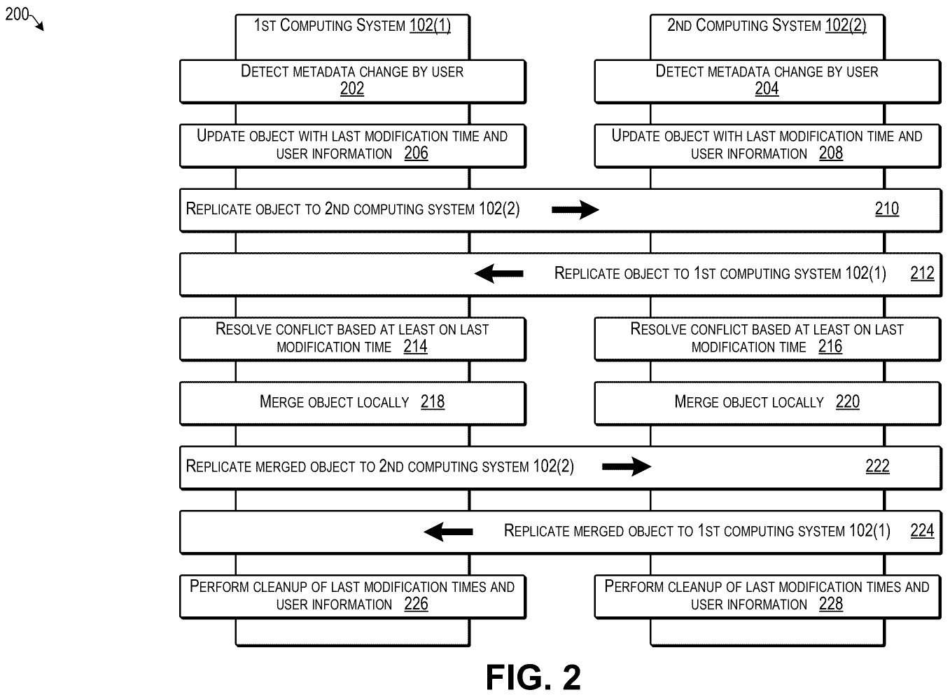

In the illustrated example of FIG. 1, suppose that a first client user 112(1) makes a metadata change 150 to the metadata 132(1) for an object stored by the first computing system 102(1), and that a second client user 112(2) makes a metadata change 152 to the metadata 132(2) for the same object stored by the second computing system 102(2). Furthermore, suppose that the changes 150, 152 to the metadata 132(1) and 132(2) for the same object conflict with each other. As one example, suppose that the metadata change 150 removes a piece of metadata from the metadata for the object at a time t₁, while the metadata change 152 adds new metadata to the object at a time t₂. The object with the change 150 to the metadata 132(1) is subsequently replicated to the computing systems 102(2) and 102(3), and the object with the change 152 to the metadata 132(2) is subsequently replicated to the computing system 102(1) and 102(3). In a conventional replication process, only the version of the object with the latest change to the metadata might survive the replication process. Thus, the change 150 made at the first computing system 102(1) might be lost because it was made earlier than the later change 152 at the second computing system 102(2). The examples herein are able to preserve both changes, and may further provide for conflict resolution following replication, as discussed below, e.g., with respect to FIGS. 2-5.

FIGS. 2-5 include flow diagrams illustrating example processes according to some implementations. The processes are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation. Any number of the described blocks can be combined in any order and/or in parallel to implement the process, or alternative processes, and not all of the blocks need be executed. For discussion purposes, the processes are described with reference to the environments, frameworks, and systems described in the examples herein, although the processes may be implemented in a wide variety of other environments, frameworks, and systems.

FIG. 2 illustrates an example process 200 for metadata conflict resolution according to some implementations herein. The conflict resolution techniques herein may be employed whenever N systems are participating in N-side replication. In this example, the conflict resolution program 124(1) may be executed on the first computing system 102(1) and the conflict resolution program 124(2) may be executed concurrently on the second computing system 102(2) to perform a series of operations for preserving and merging the metadata changes 150 and 152 discussed above with respect to the example of FIG. 1. Further, while the third computing system 102(3) is not shown in this example for clarity of illustration, some of the operations may also be performed on the third computing system 102(3), as discussed additionally below.

At 202, the first computing system 102(1) may detect the metadata change 150 made by the user 112(1) to the metadata 132(1) stored by the first computing system 102(1), as discussed above with respect to the example of FIG. 1. As one example, the conflict resolution program 124(1) may run as a background process on the computing system 102(1), and may detect changes made to the metadata 132(1) stored by the first computing system 102(1). Upon detecting a change to the metadata 132(1), the conflict resolution program 124(1) may record the exact time at which the metadata change 150 was made, and may further record user information associated with the user who made the metadata change 150.

At 204, the second computing system 102(2) may also execute the conflict resolution program 124(2) to detect the metadata change 152 made by the user 112(2) to the metadata 132(2) stored by the second computing system 102(2), as discussed above with respect to the example of FIG. 1. The conflict resolution program 124(2) may record the exact time at which the metadata change 152 was made and the user information of the user who made the metadata change 152.

At 206, the first computing system 102(1) may update the metadata 132(1) for the particular object corresponding to the changed metadata to store the last modification time (LMT) and user information of the user who last modified the individual metadata of the particular object. For example, by storing the last modification time and the user information directly with the metadata for the particular affected object (i.e., as part of the data object itself) the tracking of the change information is simplified, and the overhead is reduced, such as in the case that it becomes necessary to maintain the change information separately outside of the object. This can also help with replication of the change information, so that the last modification time and the user information of the user who last modified the individual metadata is replicated along with object itself, so there is no need to have to track and transfer the change information separately to send the change information to the other computing systems 102(2) and 102(3) (not shown in FIG. 2). Any number of changes to the metadata may be made by one or more users prior to the next replication cycle. For example, if changes are made to different pieces of the metadata, and each metadata change is retained with its own change information. On the other hand, if the same piece of metadata is changed, and then changed again at the same computing system, then only the later metadata change for that piece of metadata might be retained with a last modification time and user information, as the prior change to that particular piece of metadata has been overwritten and does not need to be replicated.

At 208, the second computing system 102(2) may update the metadata for the particular object corresponding to the changed metadata to store the last modification time and the user information of the user who changed the metadata directly with the metadata for the particular affected object.

At 210, the first computing system 102(1) may replicate the object to the second computing system 102(2). For example, the computing systems 102(1)-102(3) may be configured by executing respective instances of the replication program 122 to replicate updated objects across the computing systems 102(1)-102(3) to the other computing systems 102(1)-102(3) that are participating in object level replication, such as based on a periodic trigger or other trigger mechanism. For example, instead of replicating all changed objects at regular or irregular periods of time, the system may instead be configured to replicate any object that has had its data or metadata changed, such as within a specified time of the change being performed. Regardless of the type of replication trigger, the replicated object may include the object data and object metadata of the object to which the one or more metadata changes were made. The replicated object metadata may further include the last modification time(s) and the user information of the respective user(s) who made changes to the metadata of the object.

At 212, the second computing system 102(2) replicates the object including the modified object metadata and the change information (LMT and user information of the user who changed the metadata) to the first computing system 102(1). Furthermore, while the example of FIG. 2 only illustrates replication from the first computing system 102(1) to the second computing system 102(2), and vice versa, two-way replication also takes place between the first and second computing systems 102(1), 102(2) and the third computing system 102(3). Thus, the third computing system 102(3) (not shown in FIG. 2) also receives the objects with the modified metadata and the respective change information from each of the first computing system 102(1) and the second computing system 102(2).

At 214, the first computing system 102(1) may resolve a conflict in the changes to the metadata if a conflict exists, such as based on a comparison of the last modified time received from the second computing system 102(2) as compared with the last modified time recorded by the first computing system 102(1) for the metadata change made at the first computing system 102(1). For instance, the conflict resolution program 124(1) at the first computing system 102(1) may select the most recent last modification time as the metadata change to implement for resolving the conflict. If the last modification times are the same, the conflict resolution program 124(1) may refer to the user information of the users who made the changes to determine which user may have higher privileges with respect to the object, and may select the change made by the user having the higher privileges or other higher priority user role. As one example, suppose the first metadata change 150 changed user privileges for the object to a first specification and the second metadata change 152 changed the user privileges to a second specification. In this case, the last modification time may be applied to select the second specification for user privileges. In addition, for some types of changes, the role of the user who made the change may override the conflict resolution based on last modification time, such as in the case that the first change prohibits subsequent changes by other users. Further, other existing conflict resolution rules may be applied depending on the type of metadata changed, such as in the case that both metadata changes were to change a retention period for the object, then the longest retention period may be applied for resolving the conflict. Additionally, in the case that the changes to the metadata do not conflict, e.g., one metadata change is to user privileges for accessing the object and the other metadata change is to a retention period for the object, then the changes from both sides are merged and both metadata changes from both computing systems are retained in the single instance of the object.

At 216, concurrently with block 214, the second computing system 102(2) may resolve a conflict in the metadata if a conflict exists based on a comparison of the last modified time received from the first computing system 102(1) as compared with the last modified time recorded by the second computing system 102(2) for the metadata change made at the second computing system 102(2). The third computing system 102(3) may also perform a similar conflict resolution action. Accordingly, following the replication, each computing system 102(1)-102(3) participating in the replication now has access to both of the last modification times of the individual metadata changes 150, 152, and the corresponding user information about the users who last modified the individual metadata. Thus, each computing system 102(1)-102(3) may resolve any conflicts at the level of the individual metadata change in parallel with the other systems 102(1)-102(3) by comparing each of the last modification times of the individual metadata, and if necessary, the user information. For instance, the conflict resolution program 124 at each computing system 102 may select the most recent last modification time as the change to implement for resolving a direct conflict. If the last modification times are the same, the conflict resolution program 124 may refer to the user information of the users who made the changes to determine which user may have higher privileges with respect to the object, and may select the change made by the user having the higher privileges or having other higher-priority user role. Additionally, for some types of changes, the role of the user who made the change may override the conflict resolution based on last modification time, such as in the case that the first change prohibits subsequent changes by other users. Further, other existing conflict resolution rules may be applied for some types of conflicts. Additionally, in the case that the changes to the metadata do not conflict with each other, then the changes from both sides are merged and both metadata changes are retained in the single updated object.

At 218, following the conflict resolution, the first computing system 102(1) may locally merge the changes to the object metadata based on the conflict resolution decision. For example, the metadata changes from both computing systems 102(1) and 102(2) may be merged and retained unless they directly conflict with each other as discussed above.

At 220, following the conflict resolution, the second computing system 102(2) may locally merge the changes to the object metadata based on the conflict resolution decision. For example, the metadata changes from both computing systems 102(1) and 102(2) may be merged and retained unless they directly conflict with each other as discussed above. The third computing system 102(3) may also perform this function.

At 222, the first computing system 102(1) may replicate the merged object back to the second computing system 102(2) as part to the next replication cycle, and also to the third computing system 102(3), as well as receiving the merged object from the third computing system 102(3). For example, the merged object may be merged based on the metadata changes from each of the computing systems 102(1) and 102(2), and may be saved locally by each system.

At 224, the second computing system 102(2) may replicate the merged object back to the first computing system 102(1) as part of the next replication cycle, and also replicates the merge object to the third computing system 102(3), as well as receiving the merged object from the third computing system 102(3).

At 226, the first computing system 102(1) may delete any change information (LMTs and user information) that was saved and/or that was used for the conflict resolution. For instance, since all of the computing systems 102 perform the conflict resolution and merging process themselves, and any conflicts have been resolved, there is no longer any need to save this information. Accordingly, the change information, including any previously saved LMTs and user information for the object may be deleted locally to reduce the overall size of the object at each computing system 102.

At 228, the second computing system 102(2) may delete any change information (LMTs and user information) that was saved and/or that was used for the conflict resolution. The third computing system 102(3) may perform a similar function.

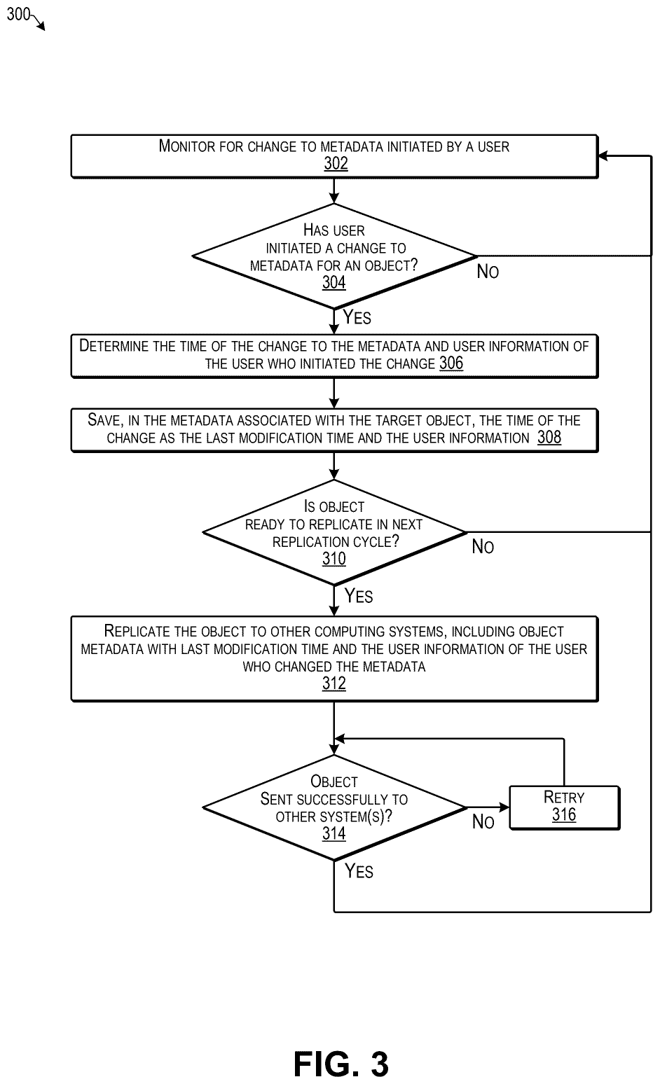

FIG. 3 is a flow diagram illustrating an example process 300 for detecting a metadata conflict according to some implementations. In some cases, the process 300 may be executed at least in part by one or more of the computing systems 102, such as by one or more computing devices 104 of the computing system 102 executing the conflict resolution program 124 and the replication program 122.

At 302, the computing system may monitor for a change to metadata initiated by a user. For example, when the metadata is maintained in a metadata database or other data structure, the computing system may monitor for any changes to the metadata in the data structure.

At 304, the computing system may determine whether a user has initiated change to the metadata for an object. If so, the process goes to 306. If not the process returns to 302 to continue monitoring.

At 306, when the system detects that a user has changed the metadata for an object, the computing system may determine the time at which the changes were made and user information of the user who initiated the change. Examples of user information may include user privileges or other user role information such as a priority level accorded to the role of the user.

At 308, the computing system may save, in the metadata associated with the target object that corresponds to the changed metadata, the time of the change as the last modification time and the user information. If a previous last modification time has already been stored in the metadata in association with the target object, the system may replace that last modification time with the new time as the last modification time.

At 310, the computing system may determine whether the object is ready to replicate in the next replication cycle. If so, the process goes to 312. If not, the process goes to 302 to monitor for any additional changes to the metadata. As mentioned above, in some cases, the replication may occur on a periodic basis, while in other examples, the replication may occur when a change to an object is detected locally at a computing system. Further, in some examples, when replication is triggered at one of the computing systems, the other computing systems participating in replication with that computing system may also be triggered to execute replication of any objects that have received changes since the last replication cycle. Implementations herein are not limited to any particular types of replication triggers or replication cycles.

At 312, the computing system may replicate the object to the other computing systems participating in the replication and may include, with the replicated object, the object metadata along with the last modification time and the user information of the user who changed the metadata.

At 314 the computing system may determine whether the object was sent successfully to the other systems in the replication. If not, the process goes to 316. If so, the process returns to 302 to monitor for new changes to the metadata made by the user.

At 316, if the object was not successfully sent to the other systems participating in the replication, the computing system may retry sending the object to the other systems.

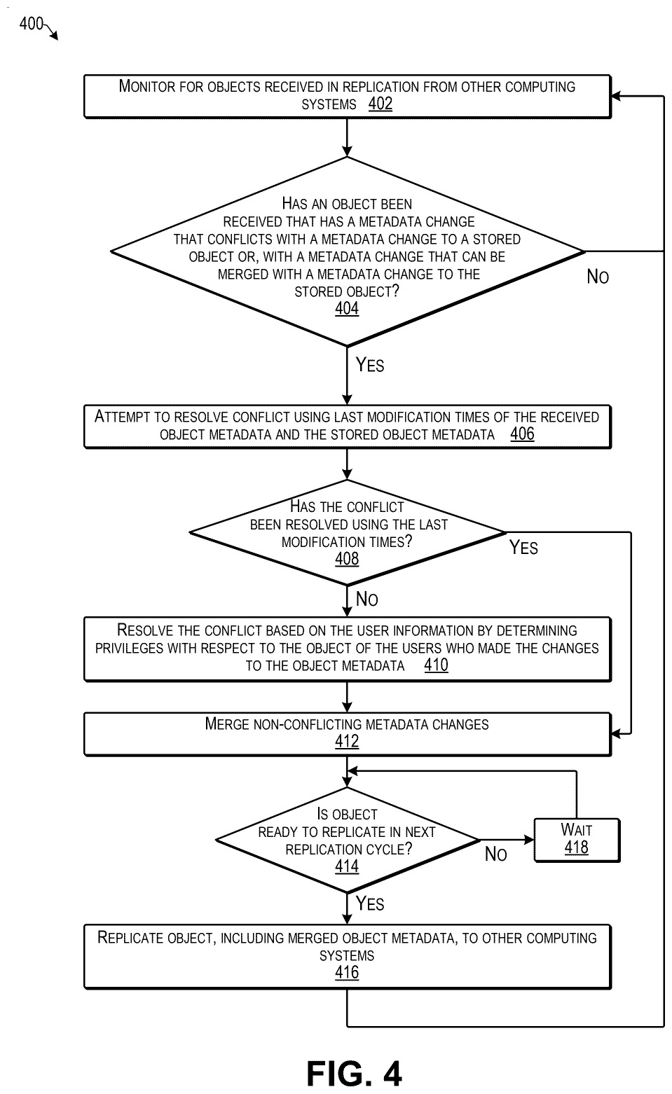

FIG. 4 is a flow diagram illustrating an example process 400 for conflict resolution and the merger of metadata changes according to some implementations. In some examples, the process 400 may be executed by one or more computing devices 104 of the computing system 102, such as by execution of the conflict resolution program 124 and the replication program 122.

At 402, the computing system may monitor for objects received in replication from other computing systems.

At 404, the computing system may determine whether an object has been received through replication that has a metadata change that conflicts with a metadata change to a stored object already stored at the computing system or, if there is not a conflict, whether the received metadata change can be merged with a metadata change made to the object already stored at the computing system. If so, the process goes to 406. If not, the process goes to 402 to continue monitoring for objects received in replication.

At 406, when there is a conflict, the computing system may attempt to resolve the conflict based at least in part by comparing the last modification times of the received object metadata change(s) and the stored object metadata change(s). For example, the computing system may determine the most recent time between the received last modification time and the stored last modification time for the metadata changes to the object. Based on determining the most recent last modification time, in some cases, the computing system may select the metadata change associated with the most recent last modification time as the metadata change to implement. Additionally, for some types of metadata changes, the role of the user who made the change may override the conflict resolution based on last modification time, such as in the case that the first change prohibits subsequent changes by other users. In this situation, the roles of the respective users who made the metadata changes may be used for resolving a conflict in the metadata changes, or alternatively, other conflict resolution rules may be applied as discussed elsewhere herein.

At 408, the computing system may determine whether the conflict has been resolved using the comparison of the last modification times. If so, the process goes to 412. If not, the process goes to 410.

At 410, when the conflict is not resolved based on the comparison of the last modification times, the computing system may resolve the conflict based on the user information by determining privileges with respect to the object of the users who made the changes to the object metadata. As one example, if the last modification times are the same, or if the conflict cannot otherwise be resolved based on the last modification time comparison, the computing system may select the metadata change made by the user that has the higher level of user privileges (e.g., corresponding to a higher priority role) with respect to the particular data object. Further, in some cases, other rules for resolving metadata conflicts may be applied, such as in the case in which the retention period is changed, in which case, the longest retention period is applied. Thus, various other conflict resolution rules, as are known in the art, may be applied in specific situations.

At 412, when there are metadata changes that do not conflict and/or when any conflicts have been resolved, the computing system may merge the non-conflicting metadata changes, if any. For example, in some cases, two or more of the metadata changes may not conflict, in which case the metadata changes from two or more computing systems may be retained and all the non-conflicting metadata changes may be merged into a single instance of the object.

At 414, the computing system may determine whether the object is ready to replicate in the next replication cycle. For example, the computing system may wait until the next replication cycle before sending the object with the merged metadata to the other computing systems. If so, the process goes to 416. If not, the process goes to 418.

At 416, the computing system may replicate the object including the merged object metadata to the other computing systems participating in the replication.

At 418, if it is not yet time for the next replication cycle, the system may wait until the next replication cycle arrives.

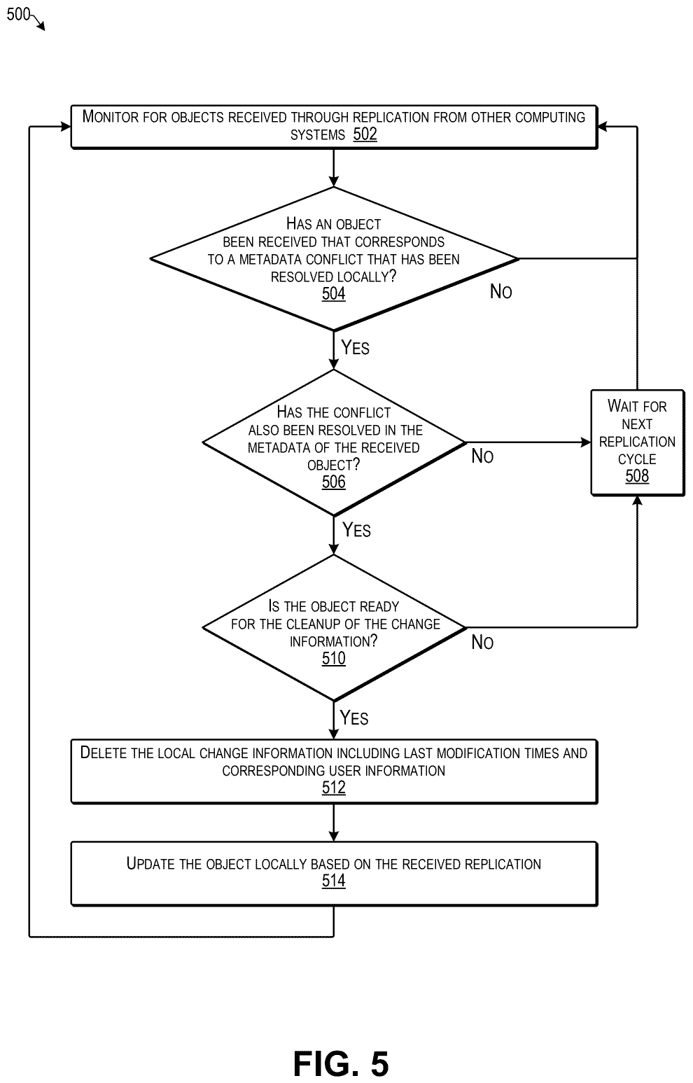

FIG. 5 is a flow diagram illustrating an example process 500 for performing cleanup following conflict resolution and merging of changes according to some implementations. In some examples, the process 500 may be executed by one or more computing devices of the computing system 102, such as by execution of the conflict resolution program 124 and the replication program 122.

At 502, the computing system may monitor for objects received through replication from other computing systems.

At 504, the computing system may determine whether an object has been received that corresponds to a metadata conflict or other multi-system metadata changes that have been resolved locally, merged, or the both. For instance, if the computing system resolved locally a metadata conflict or otherwise merged metadata changes made at multiple computing systems for a particular object, the computing system may determine whether the same object has been received through replication from another computing system. If so, the process goes to 506. If not, the process returns to 502 to monitor for additional objects received through the replication.

At 506, the computing system may determine whether the conflict or other metadata changes have also been resolved and/or merged in the metadata of the received object that corresponds to the object for which the metadata conflict has been resolved locally. If so, the process goes to 510. If not, the process goes to 508.

At 508, the computing system may wait for the next replication cycle to see if the other computing system resolves the multi-system changes in the metadata.

At 510, the computing system may determine whether the object is ready for the cleanup of the change information. For example, when the computing system determines that any conflict has been resolved and/or the metadata changes have been merged by all of the computing systems, the computing system may proceed with cleanup of the change information locally. If so, the process goes to 512. If not, the process goes to 508 to wait for the next replication cycle.

At 512, the computing system may delete the local change information including last modification time(s) and corresponding user information. For example, a location in the metadata for the object may be cleared of this information.

At 514, the computing system may update the object locally based on the received replication. For example, if any other changes were made to the object, these changes may be updated on the local object.

The example processes described herein are only examples of processes provided for discussion purposes. Numerous other variations will be apparent to those of skill in the art in light of the disclosure herein. Additionally, while the disclosure herein sets forth several examples of suitable frameworks, architectures and environments for executing the processes, implementations herein are not limited to the particular examples shown and discussed. Furthermore, this disclosure provides various example implementations, as described and as illustrated in the drawings. However, this disclosure is not limited to the implementations described and illustrated herein, but can extend to other implementations, as would be known or as would become known to those skilled in the art.

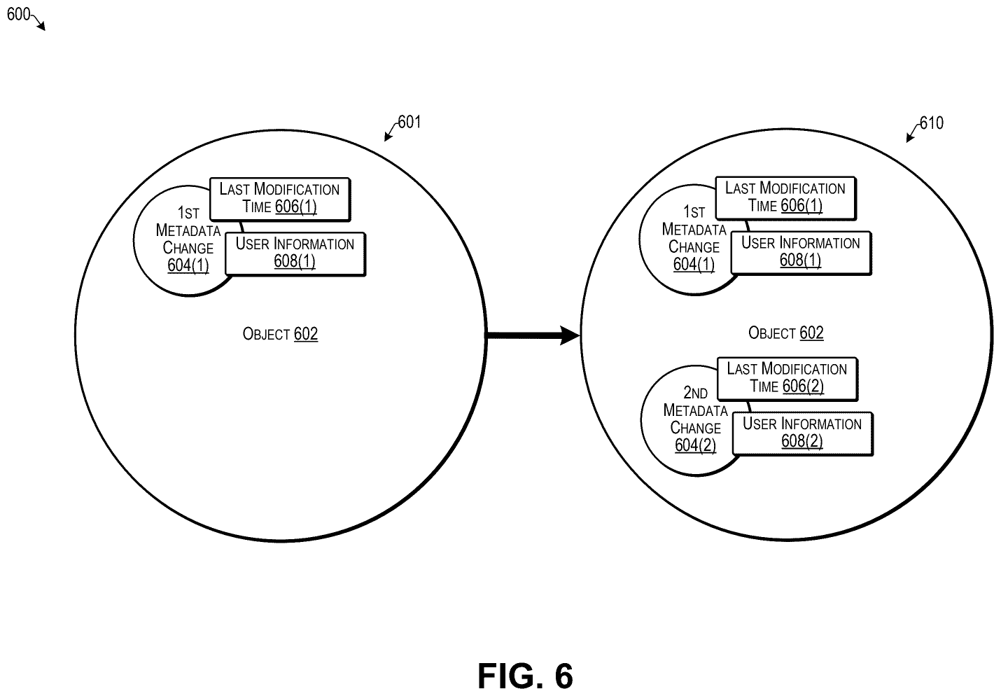

FIG. 6 illustrates an example 600 of storing the last modification time and user information in association with metadata changes according to some implementations. In this example, as indicated at 601, suppose that a user makes a first metadata change 604(1) to an object 602. Based on detecting this, the computing system may associate, with the first metadata change 604(1), a last modification time 606(1) that indicates the time at which the first metadata change 604(1) was made by the user. In addition, the computing system also associates, with the first metadata change 604(1), user information 608(1) of the user that made the first metadata change 604(1). As one example, the user information 608(1) may include at least a role of the user who made the first metadata change 604(1), which may include a priority of the user and/or privileges of the user with respect to the object 602. Accordingly, the last modification time 606(1) and the user information 608(1) may be stored as part of the metadata of the object 602 and therefore form a part of the object 602.

Subsequently, as indicated at 610, suppose that the same user or a different user makes a second metadata change 604(2) to some other metadata of the object 602 at the same computing system. Based on detecting the second metadata change 604(2), the computing system associates a last modification time 606(2) with the second metadata change 604(2). The computing system also associates, with the second metadata change 604(2), user information 608(2) of the user who made the second data metadata change 604(2). As mentioned previously, any number of changes to the metadata may be made by one or more users at the same computing system prior to the next replication cycle. For example, if changes are made to different pieces of the metadata, each metadata change is retained in the object 602 with its own change information (LMT and user information). On the other hand, if the same piece of metadata is changed at, e.g., the first computing system 1021), and then changed again at the first computing system 102(1), then only the later metadata change for that piece of metadata might be retained in the object 602 with a last modification time and user information, as the prior change to that particular piece of metadata has been overwritten and does not need to be replicated.

During replication of object 602 to another computing system, both the first metadata change 604(1) and the second metadata change 604(2) along with their respective change information (i.e., LMT 606(1), user information 608(1), LMT 606(2), and user information 608(2)), may be replicated to the other computing system(s) participating in the replication topology. In some examples, if another user also makes a third metadata change to an instance of the object 602 stored at a second computing system (not shown in FIG. 6), then subsequent to replication, both the first metadata change 604(1) and the second metadata change 604(2) may be merged with the third metadata change made at the second computing system if they do not conflict with the third metadata change, or alternatively, if there is a conflict, the conflict may be resolved as discussed above.

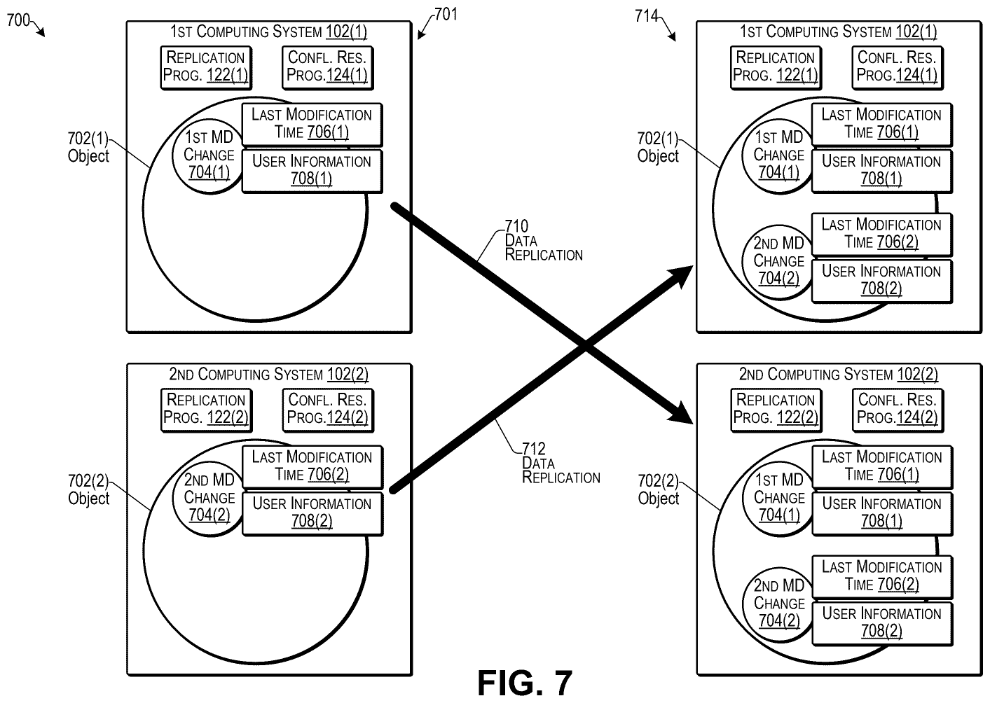

FIG. 7 illustrates an example 700 of merging metadata changes according to some implementations herein. In some examples, suppose that the first computing system 102(1) corresponds to the first computing system 102(1) discussed above with respect to FIGS. 1 and 2, and that the second computing system 102(2) corresponds to the second computing system 102(2) discussed above with respect to FIGS. 1 and 2 (computing system 102(3) is omitted for clarity of illustration, or may be omitted altogether in this example).

At 701, suppose that before replication is performed, the first computing system 102(1) includes a first instance of an object 702(1) and the second computing system 102(2) includes a second instance of the object 702(2). Furthermore, suppose that a first user makes a first metadata change 704(1) to the metadata of the first instance of the object 702(1) at the first computing system 102(1), and a second user makes a second metadata change 704(2) to the metadata of the second instance of the object 702(2) at the second computing system 102(2). Based on the metadata change 704(1), the first computing system 102(1) associates a last modification time 706(1) and user information 708(1) with the first metadata change 704(1). Furthermore, based on the metadata change 704(2), the second computing system 102(2) associates the last modification time 706(2) and user information 708(2) with the second metadata change 704(2).

Subsequently, suppose that data replication 710 is performed to replicate the first instance of the object 702(1) to the second computing system 102(2), and that data replication 712 is performed to replicate the second instance of the object 702(2) to the first computing system 102(1). As indicated at 714, each of the first computing system 102(1) and the second computing system 102(2) may execute its respective conflict resolution program 124(1) or 124(2), respectively, to resolve a conflict, if any, between the first metadata change 704(1) and the second metadata change 704(2). In this example, suppose that there is not a conflict between the first metadata change 704(1) and the second metadata change 704(2). For example, the first metadata change 704(1) may be a change to user privileges for the object 702, and the second metadata change 704(2) may be for a change to a retention period for the object 702. In this case, since no conflict resolution is necessary, the first metadata change 704(1) and the second metadata change 704(2) are merged into a single object 702 at each computing system 102(1) and 102(2) so that the metadata changes from both computing systems 102(1) and 102(2) are retained in the single instance of the object 702(1) and 702(2) stored at each system 102(1) and 102(2), respectively.

Furthermore, in some examples, as mentioned above, there may be more than two metadata changes, some of which may conflict with metadata changes made at other computing systems, and some of which do not conflict. In this situation, the conflicts between two or more metadata changes may be resolved, such as by using the last modification time, user roles, or other conflict resolution rules. Following resolution of any conflicting changes, the resolved metadata changes and any other non-conflicting metadata data changes are merged into a single object at each computing system, as discussed above.

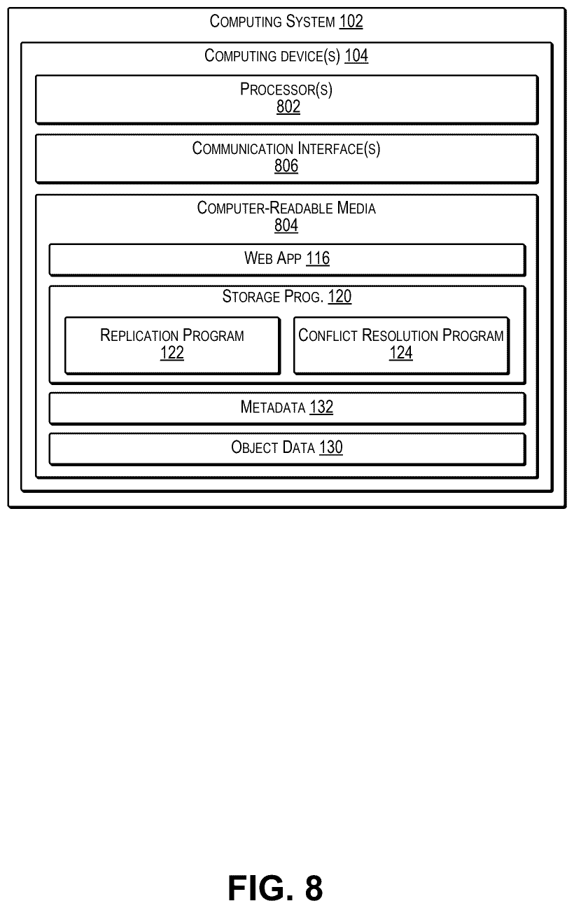

FIG. 8 illustrates select example components of an example computing system 102 that may be used to implement some of the functionality of the systems described herein. The computing system 102 includes the one or more computing devices 104, which may include one or more servers or other types of computing devices that may be embodied in any number of ways. Additionally, in some examples, the computing devices 104 may also include, or may be in communication with, one or more storage systems, storage controllers, network attached storage, storage arrays, storage area networks, or the like. For instance, in the case of a server, the programs, other functional components, and data may be implemented on a single server, a cluster of servers, a server farm or data center, a cloud-hosted computing service, and so forth, although other computer architectures may additionally or alternatively be used. Multiple computing devices 104 may be located together or separately, and organized, for example, as virtual servers, server banks, and/or server farms. The described functionality may be provided by the servers of a single entity or enterprise, or may be provided by the servers and/or services of multiple different entities or enterprises.

In the illustrated example, the computing devices 104 include, or may have associated therewith, one or more processors 802, one or more computer-readable media 804, and one or more communication interfaces 806. Each processor 802 may be a single processing unit or a number of processing units, and may include single or multiple computing units, or multiple processing cores. The processor(s) 802 can be implemented as one or more central processing units, microprocessors, microcomputers, microcontrollers, digital signal processors, graphics processing units, system-on-chip processors, state machines, logic circuitries, and/or any devices that manipulate signals based on operational instructions. As one example, the processor(s) 802 may include one or more hardware processors and/or logic circuits of any suitable type specifically programmed or configured to execute the algorithms and processes described herein. The processor(s) 802 may be configured to fetch and execute computer-readable instructions stored in the computer-readable media 804, which may program the processor(s) 802 to perform the functions described herein.

The computer-readable media 804 may include volatile and nonvolatile memory and/or removable and non-removable media implemented in any type of technology for storage of information, such as computer-readable instructions, data structures, program modules, or other data. For example, the computer-readable media 804 may include, but is not limited to, RAM, ROM, EEPROM, flash memory or other memory technology, optical storage, solid state storage, magnetic tape, and magnetic disk storage, or any other medium that can be used to store the desired information and that can be accessed by a computing device. Further, in some examples, the computer-readable media 804 includes network storage systems, which may include storage arrays, network attached storage, storage area networks, cloud storage, and the like, as described elsewhere herein.

Depending on the configuration of the computing systems 102, the computer-readable media 804 may be a tangible non-transitory medium to the extent that, when mentioned, non-transitory computer-readable media exclude media such as energy, carrier signals, electromagnetic waves, and/or signals per se. In some cases, the computer-readable media 804 may be at the same location as the computing system 102, while in other examples, the computer-readable media 804 may be partially remote from the computing system 102.

The computer-readable media 804 may be used to store any number of functional components that are executable by the processor(s) 802. In many implementations, these functional components comprise instructions or programs that are executable by the processor(s) 802 and that, when executed, specifically program the processor(s) 802 to perform the actions attributed herein to the computing system 102. Functional components stored in the computer-readable media 804 may include the web application 116 and the storage program 120, including the replication program 122 and the conflict resolution program 124, each of which may include one or more computer programs, applications, modules, executable code, or portions thereof. Further, while these programs are illustrated together in this example, in some examples these programs may be separate programs and/or during use, some or all of these programs may be executed on separate computing devices 104 at a respective computing system 102.

In addition, the computer-readable media 804 may store data, data structures, and other information used for performing the functions and services described herein. For example, the computer-readable media 804 may store one or more data structures that contain the metadata 132, and the computer readable media 804 may also store the object data 130. The computing system 102 may also include or maintain other functional components and data, which may include programs, drivers, etc., and the data used or generated by the functional components. Further, the computing system 102 may include many other logical, programmatic, and physical components, of which those described above are merely examples that are related to the discussion herein.

The one or more communication interfaces 806 may include one or more software and hardware components for enabling communication with various other devices, such as over the one or more network(s) 106. For example, the communication interface(s) 806 may enable communication through one or more of a LAN, the Internet, cable networks, cellular networks, wireless networks (e.g., Wi-Fi) and wired networks (e.g., Fibre Channel, fiber optic, Ethernet), direct connections, as well as close-range communications such as BLUETOOTH®, and the like, as additionally enumerated elsewhere herein.

Various instructions, methods, and techniques described herein may be considered in the general context of computer-executable instructions, such as computer programs and applications stored on computer-readable media, and executed by the processor(s) herein. Generally, the terms program and application may be used interchangeably, and may include instructions, routines, scripts, modules, objects, components, data structures, executable code, etc., for performing particular tasks or implementing particular data types. These programs, applications, and the like, may be executed as native code or may be downloaded and executed, such as in a virtual machine or other just-in-time compilation execution environment. Typically, the functionality of the programs and applications may be combined or distributed as desired in various implementations. An implementation of these programs, applications, and techniques may be stored on computer storage media or transmitted across some form of communication media.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

1. A system comprising:
a first computing device of a first computing system able to communicate over a network with a second computing device of a second computing system, wherein data is replicated between the first computing system and the second computing system, the first computing device configured to perform operations comprising:
receiving, by the first computing device, a first metadata change made to metadata of a first instance of an object stored at a storage location associated with the first computing device;
associating, by the first computing device, with the first metadata change, a time of the first metadata change;
based on receiving replication of a second instance of the object from the second computing device of the second computing system, determining that a second metadata change was made to metadata of the second instance of the object at the second computing system, wherein the second instance of the object includes a time of the second metadata change; and at least one of:
resolving, by the first computing device, a conflict between the first metadata change and the second metadata change based at least in part on comparing the time of the first metadata change with the time of the second metadata change, or
merging, by the first computing device, the first metadata change with the second metadata change into the metadata for the object.

2. The system as recited in claim 1, the operations further comprising resolving, by the first computing device, the conflict based in part on a comparison of user information related to a first user indicated to be a source of the first metadata change with user information related to a second user indicated to be a source of the second metadata change.

3. The system as recited in claim 2, wherein the user information related to the first user indicates at least one of:
a role of the first user with respect to the object, or
privileges of the first user with respect to the object.

4. The system as recited in claim 1, the operations further comprising replicating, by the first computing device, the first instance of the object to the second computing device at the second computing system, wherein the second computing device at the second computing system is configured to resolve the conflict between the first metadata change and the second metadata change based at least in part on comparing the time of the first metadata change with the time of the second metadata change.

5. The system as recited in claim 1, the operations further comprising:
replicating, by the first computing device, the first instance of the object to a third computing device at a third computing system;
replicating, by the second computing device, the second instance of the object to the third computing device at the third computing system; and
wherein the third computing device at the third computing system is configured to resolve the conflict between the first metadata change and the second metadata change based at least in part on comparing the time of the first metadata change with the time of the second metadata change.

6. The system as recited in claim 5, wherein the first computing system, the second computing system and the third computing system are arranged in an active-active ring replication configuration.

7. The system as recited in claim 1, wherein the time of the first metadata change is stored with the metadata of the first instance of the object and replicated with the metadata of the first instance of the object during replication of data to the second computing device at the second computing system.

8. The system as recited in claim 1, wherein the operation of merging the first metadata change with the second metadata change into the metadata for the object further comprises:
storing, by the first computing device, both the first metadata change and the second metadata change in the metadata of the first instance of the object stored by the first computing device.

9. The system as recited in claim 8, the operations further comprising:
receiving, by the first computing device, in replication of data received from the second computing device, a third instance of the object in which the first metadata change has been merged with the second metadata change.

10. The system as recited in claim 9, the operations further comprising:
based at least on determining that the metadata of the third instance of the object includes the first metadata change and the second metadata change, deleting, from the metadata associated with the first instance of the object, the time associated with the first metadata change and user information associated with the first metadata change.

11. The system as recited in claim 1, wherein a third metadata change is received with the replication of the second instance of the object from the second computing device of the second computing system, the operations further comprising:
resolving a conflict between the first metadata change and the second metadata change based at least in part on comparing the time of the first metadata change with the time of the second metadata change to select a metadata change from the first metadata change and the second metadata change based on resolving the conflict;
determining that the third metadata change does not conflict with the selected metadata change; and
merging the third metadata change and the selected metadata change into a single instance of the object at the first computing system.

12. A method comprising:
receiving, by the first computing device associated with a first computing system, a first metadata change made to metadata of a first instance of an object stored at a storage location associated with the first computing device;
associating, by the first computing device, with the first metadata change, a time of the first metadata change;
based on receiving replication of a second instance of the object from the second computing device associated with a second computing system, determining that a second metadata change was made to metadata of the second instance of the object at the second computing system, wherein the second instance of the object includes a time of the second metadata change; and at least one of:
resolving, by the first computing device, a conflict between the first metadata change and the second metadata change based at least in part on comparing the time of the first metadata change with the time of the second metadata change, or
merging, by the first computing device, the first metadata change with the second metadata change into the metadata for the object.

13. The method as recited in claim 12, further comprising resolving, by the first computing device, the conflict based in part on a comparison of user information related to a first user indicated to be a source of the first metadata change with user information related to a second user indicated to be a source of the second metadata change.

14. One or more non-transitory computer-readable media storing one or more programs executable by a first computing device of a first computing system to configure the first computing device to perform operations comprising:
receiving, by the first computing device, a first metadata change made to metadata of a first instance of an object stored at a storage location associated with the first computing device;
associating, by the first computing device, with the first metadata change, a time of the first metadata change;
based on receiving replication of a second instance of the object from a second computing device associated with a second computing system, determining that a second metadata change was made to metadata of the second instance of the object at the second computing system, wherein the second instance of the object includes a time of the second metadata change; and at least one of:
resolving, by the first computing device, a conflict between the first metadata change and the second metadata change based at least in part on comparing the time of the first metadata change with the time of the second metadata change, or
merging, by the first computing device, the first metadata change with the second metadata change into the metadata for the object.

15. The one or more non-transitory computer-readable media as recited in claim 14, the operations further comprising resolving, by the first computing device, the conflict based in part on a comparison of user information related to a first user indicated to be a source of the first metadata change with user information related to a second user indicated to be a source of the second metadata change.
